(19) United States
(12) Patent Application Publication
(10) Pub. No.: US 2015/0178297 A1
(43) Pub. Date: Jun. 25, 2015

(54) Method to Preserve Shared Blocks when Moved

(71) Applicant: INTERNATIONAL BUSINESS MACHINES CORPORATION, Armonk, NY (US)

(72) Inventors: Janet E. Adkins, Austin, TX (US); David J. Craft, Wimberly, TX (US); Andrew N. Solomon, Austin, TX (US)

(73) Assignee: INTERNATIONAL BUSINESS MACHINES CORPORATION, Armonk, NY (US)

(21) Appl. No.: 14/140,032

(22) Filed: Dec. 24, 2013

(51) Int. Cl. G06F 17/30

(52) U.S. Cl. CPC G06F 17/30088

(57) ABSTRACT

A method, system and computer-usable medium are disclosed for tracking blocks moved within a file system, comprising: associating tracking information with a base object within the file system; tracking movement of the base object via the tracking information; and, adjusting information relating to an associated object of the base object derived from the base object.

### BACKGROUND OF THE INVENTION

1. Field of the Invention

The present invention relates in general to the field of computers and similar technologies, and in particular to software utilized in this field. Still more particularly, it relates to a method, system and computer-usable medium for preserving shared block information when the blocks are moved within a file system.

2. Description of the Related Art

Operating systems are a basic component in many computer systems. Operating systems include file systems, which organize and store data within main memory and on disk (or other persistent storage). An operating system manages data in the file system with various system operations, such as operations which read and write the data in the file system. In many operating systems, storage space in the file system can be made available by removing files or data. Additionally, some operating systems include redirect-on-write file systems which perform special operations for freeing data.

Redirect-on-write (ROW) file systems write modified file system data to new locations rather than modifying the data in a previous location. A snapshot of a file system object is created by having the snapshot point to the same locations for the data. A new modification of the object writes the data to a new location and leaves the snapshot's point-in-time view unchanged. For unchanged data this operation can result in more than one object pointing to the same data block in the file system.

Sharing of data blocks presents an issue when the size of a file system is reduced (i.e., is shrunk). One general approach to shrink a file system finds all blocks allocated at the end of the file system past the requested new size of the file system (i.e., the region of the file system to be truncated) This end of the file system is also sometimes referred to as the fence. These blocks are then moved into free blocks in the file system before the fence. The object referring to the block is updated to point to the new location. For a file system with snapshots where the blocks are pointed to by one or many objects this operation can become much more difficult. If each occurrence of the block is moved to a new location then there could be not enough space in the file system to address all of the blocks as now a plurality of copies of the same block are needed.

An issue arises when moving shared blocks. More specifically, a file system design which includes persistent snapshots and clones in a file system can result in multiple objects sharing the same block. This file system design can provide increased storage efficiency for snapshots and clones and minimal performance impact when creating the snapshot or clone. However this file system design can pose difficulties for other file system operations when blocks are moved from their original location to a new location. There are at least two options for handling a shared block when it is being moved: duplicate the block for each object which shares the block and adjust the object to point to its new unique location and/or maintain the shared state of the block by duplicating the block in a single location and adjusting each object to point to the new location of the block.

Shrinking a file system often requires shared blocks to move. For this operation it would be undesirable to break the shared blocks apart (i.e., to duplicate the blocks) since this operation could result in the file system running out of space. Other operations which could result in movement of shared blocks include: a shrink tier operation, a migrate file to new tier operation, a defragmentation operation, a file system repair operation (e.g., such as by using a file system debugger (fsdb)), and a split a clone operation (such as where the clone itself has snapshots). Accordingly, it would be desirable to provide preserve shared blocks regardless of operation.

### SUMMARY OF THE INVENTION

In one embodiment, the invention relates to a computer-implemented method for tracking blocks moved within a file system, comprising: associating tracking information with a base object within the file system; tracking movement of the base object via the tracking information; and, adjusting information relating to an associated object of the base object derived from the base object.

In another embodiment, the invention relates to system comprising: a processor; a data bus coupled to the processor; and a computer-usable medium embodying computer program code. The computer-usable medium is coupled to the data bus and is includes computer program code used for tracking blocks moved within a file system and comprising instructions executable by the processor and configured for: associating tracking information with a base object within the file system; tracking movement of the base object via the tracking information; and, adjusting information relating to an associated object of the base object derived from the base object.

In another embodiment, the invention relates to a non-transitory, computer-readable storage medium embodying computer program code, the computer program code comprising computer executable instructions configured for: associating tracking information with a base object within the file system; tracking movement of the base object via the tracking information; and, adjusting information relating to an associated object of the base object derived from the base object.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an exemplary computer in which the present invention may be implemented.

FIG. 2 shows a flow chart of the operation of processing blocks via a shared block preservation system.

FIG. 3 shows a flow chart of the operation of processing files, snapshots and clones via a shared block preservation system.

FIG. 4 shows a block diagram of a shared block preservation system.

### DETAILED DESCRIPTION

A method, system and computer-usable medium are disclosed for keeping track of blocks moved for a base object via tracking information. The procedure then uses this tracking information to also adjust any snapshot objects or clone objects derived from a base object. The tracking information can also be expanded while the snapshot or clone objects are traversed for blocks which are not shared with the base object but are shared with other snapshot or clone objects.

This procedure can also be used for other operations which also require blocks to be moved but require the shared state of blocks to be unchanged. Examples of other operations which could utilize this procedure include moving data across storage tiers, defrag, a file system repair utility, and splitting a clone file from its base file when the clone file has snapshots.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

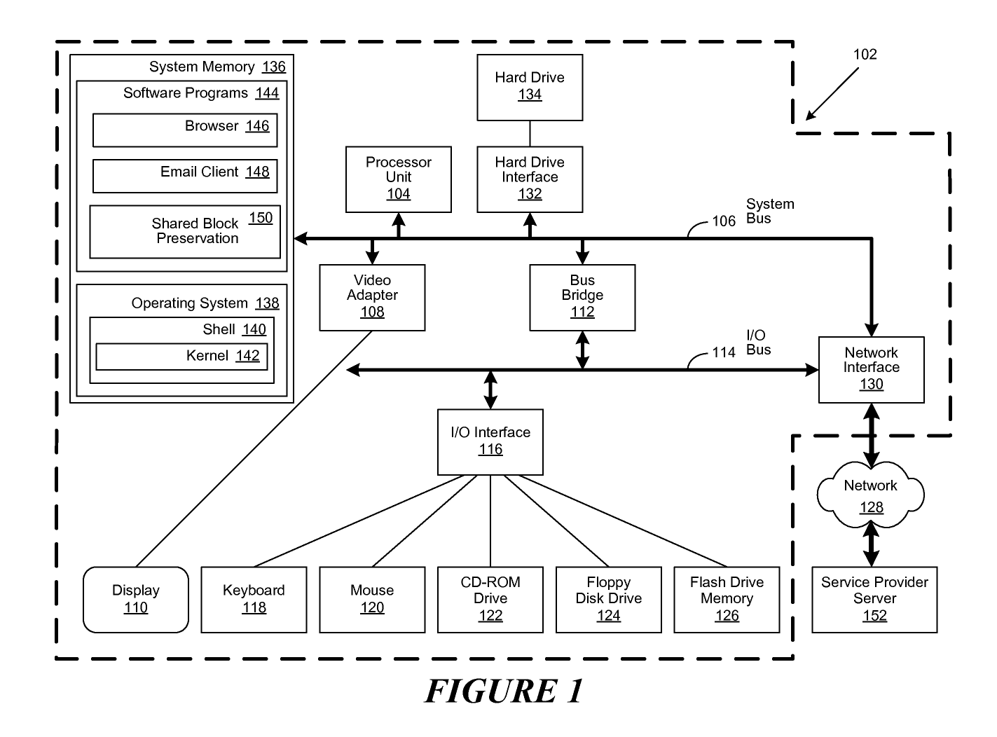

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and software programs 144, including memory management, process and task management, disk management, and mouse and keyboard management. Software programs 144 may include a browser 146 and email client 148. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. In various embodiments, software programs 144 may also include a shared block preservation system 150. In certain embodiments, the shared block preservation system 150 may be included within the kernel 142. In these and other embodiments, the shared block preservation system 150 includes code for implementing the processes described hereinbelow. In one embodiment, client computer 102 is able to download the shared block preservation system 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit, scope and intent of the present invention.

In general, when processing blocks via the shared block preservation system 150, the shared block preservation system 150 traverses file system objects stored within the file system and generates a searchable mapping of the file system objects. This mapping is referred to as a move list (mList). The mList contains information for each block which identifies where the block was originally located and to where the block was moved. The mList can be searched a plurality of ways including searching based upon the source block. A leading edge file is the first object searched. Then on subsequent passes through the mList any snapshots or clones based on the file are also searched. These objects can include sharing blocks with the leading edge or with the other snapshots or clones. A lookup in the mList is first performed to determine whether the block has already been moved to a new location. The mList can be organized in any of a plurality of organizational structures. One organization structure uses indirect blocks to generate the mapping of the source address. The data for the indirect blocks is stored as a destination block address.

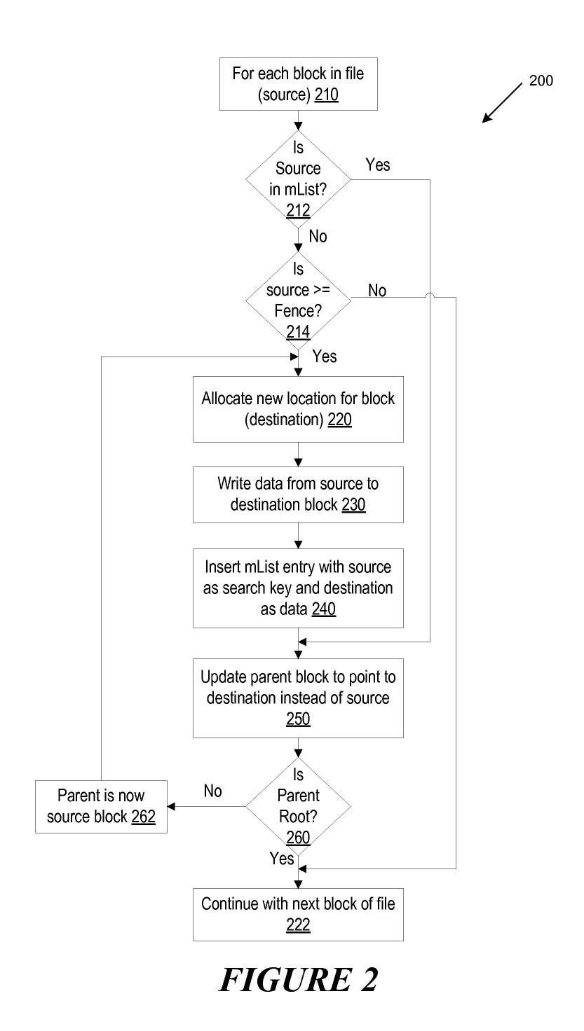

FIG. 2 shows a flow chart of the operation 200 of processing blocks via the shared block preservation system 150. More specifically, the shared block preservation system 150 performs a block processing operation for each block within each file in the file system as indicated by step 210. The block being processed is called the source block in the following steps. Next, the shared block preservation system 150 determines whether the source block is contained within the move list at step 212. If not, then at step 214, the shared block preservation system 150 determines whether the source block location is greater than or equal to a fence location. If the source block location is not greater than or equal to a fence location, then the shared block preservation system 150 continues to the next block within the source file at step 222.

If the source location is greater than or equal to a fence location, then the shared block preservation system 150 allocates a new location for the block and identifies this location as a destination block at step 220. Next, at step 230, the shared block preservation system 150 writes data from the source block to the destination block. Next, at step 240, the shared block preservation system 150 generates an mList entry with the source block as a search key and the destination block as data. Next at step 250, the shared block preservation system 150 updates the parent block of the source block being processed to point to the destination block location rather than the source block location. If the source block is contained within the move list as determined by step 212, then the shared block preservation system 150 also proceeds to step 250.

Next at step 260, the shared block preservation system determines whether the parent block is a root block. If the parent block is not a root block, then the shared block preservation system 150 identifies the parent block as the source block at step 262 and returns operation to step 220. If the parent block is a root block, then the shared block preservation system 150 continues to the next block within the file at step 222. In certain embodiments, the file system uses a hierarchical structure which may include multiple levels depending on the size of the file. The top of this structure is the root block.

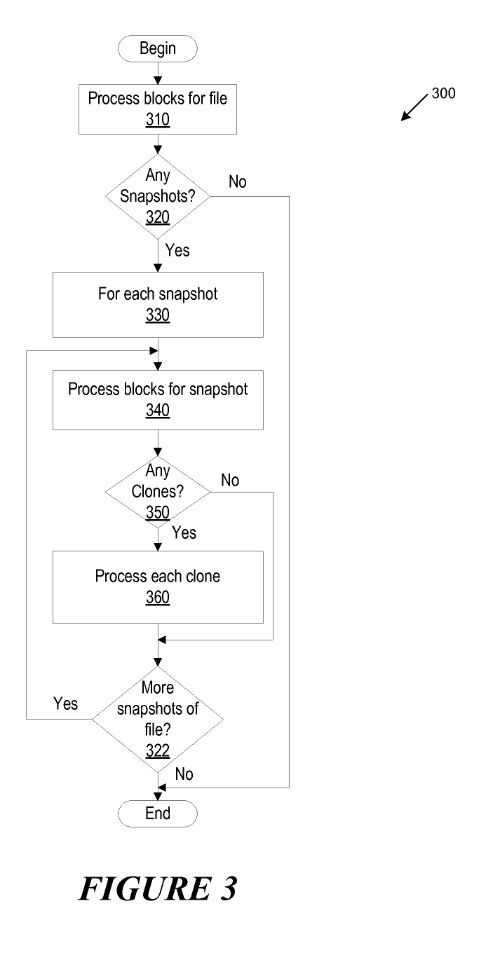

FIG. 3 shows a flow chart of the operation 300 of processing files, snapshots and clones via the shared block preservation system 150. More specifically, when processing files, snapshots and clones via the shared block preservation system 150, the shared block preservation system 150 begins operation by processing blocks for the file at step 310. The blocks of the file are processed as shown starting at 210. Next, at step 320, the shared block preservation system 150 determines whether the file has any snapshots (i.e., read-only point in time preserved images of the target file). If not, then the shared block preservation system 150 continues with the next file in the file system. If the file does have any snapshots, then the shared block preservation system 150 proceeds to step 330 where the shared block preservation system 150 identifies each snapshot created from the file and enters a loop for each snapshot created from the file. Next at step 340, the shared block preservation system 150 processes the blocks which correspond to the snapshot (as determined during operation 200). Next at step 350, the shared block preservation system 150 determines whether there are any clones (i.e., writable copies of a snapshot where a clone starts with a point in time view of a target file which can be modified by a user) created from the snapshot. If not, then the shared block preservation system 150 proceeds to step 322 where the shared block preservation system 150 determines whether there are any more snapshots of the file. If so, then the shared block preservation system 150 proceeds to step 360 where the shared block preservation system 150 identifies each clone created from the file and proceeds at 310 for each clone.

After processing each clone as a file, the shared block preservation system 150 proceeds to step 322 where the shared block preservation system 150 determines whether there are any more snapshots created from the file. If so, then the shared block preservation system returns to step 340 to process the blocks for the next snapshot. If not, then the shared block preservation system 150 completes operation for this file.

For each regular file in the file system, the shared block preservation system processes by performing operation 300. During the processing of operation 300, the operation 200 is used to process the blocks for each file (i.e., via step 310), snapshot (i.e., via step 340), and clone (i.e., via steps 310 and 360) processed.

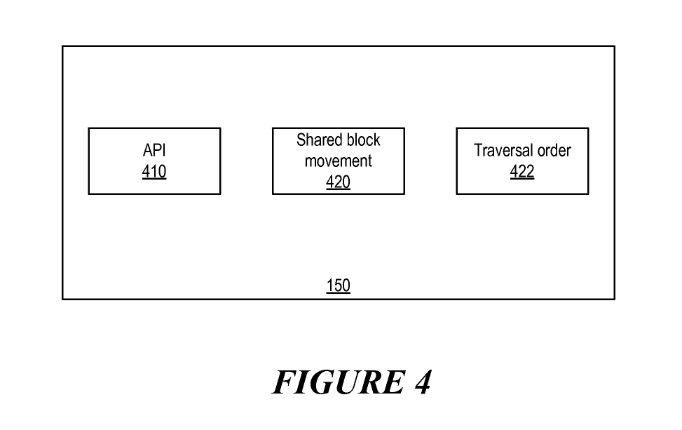

Referring to FIG. 4, a block diagram of a shared block preservation system 150 is shown. More specifically, in various embodiments, the shared block preservation system 150 includes one or more of an application program interface (API) module 410, a shared block movement module 420, and a traversal order module 422.

With the shared block preservation system 150, an ancestor object is defined as an object which was the target object when creating a snapshot or clone. A dependent object is defined as an object derived from another object resulting in shared or inherited blocks. A dependent object may be either snapshots or clones. A logical subtree contains a set of all the snapshots, and clones derived from one primary file. The primary file can itself be a regular file or a clone.

With the shared block preservation system 150, the API module 410 includes an API definition that provides a generic interface with the shared block preservation system 150. The generic interface can specify top level objects to process including file or clone objects. The interface accepts a comparison function to determine if block should move opaque data (e.g., the block could contain a fence value). The interface can include a provision to specify the object by fence and flag which is then saved in a header page of the object. The comparison function can then be based on the header for recovery purposes. The interface provides provision to accept a fsdb/defrag type operation, to add block to an mList for specified object, to create an mList object and to traverse logical subtree.

With the shared block preservation system 150, the shared block movement module 420 performs a plurality of operations. More specifically, the shared block movement module 410 locates all objects pointing to a block. Additionally, the shared block movement module 410 manages the movement of blocks that have a source location from one or more tiers. For example if the operation is to shrink a tier all the source blocks could come from a single tier. However if the operation is to migrate a file to a new tier the source blocks could be from a number of different tiers. Additionally, the shared block movement module 410 minimizes the number of traversals required when performing movement of blocks and attempts to stop a traversal when the traversal is no longer necessary. Additionally, the shared block movement module 410 supports moving shared blocks using on-disk space. These blocks and the original location of the moved blocks are then freed as soon as reasonably possible to avoid holding too much of the free space in the file system. Additionally, the shared block movement module 410 supports an interruptible operation such as on a file system unmount condition. Additionally, the shared block movement module 410 supports a restart operation that does not repeat work that has already been completed.

More specifically, when performing a shared block movement operation, a file structure corresponding to the object (e.g., logical subtree structures which show snapshots and clones created from the object) is searched to find all blocks requiring movement. The blocks can include both indirect and direct blocks. The required block movement can be due to a number of reasons. These reasons may include the block meeting the search criteria. (E.g. it is after the fence or the tier is incorrect); a child block was moved thus requiring an update to an indirect block (if the only changes for the indirect block are due to blocks being moved the indirect block is itself moved to preserve space-efficiency with any dependent objects); and, the block was already moved by an ancestor.

Movement of shared blocks uses a depth-first search or a depth-limited search operation depending on the object being traversed. A leading edge object is searched using depth-first. A dependent object is searched using a depth-limited search. The limit is not based on the depth in the tree but based on finding blocks which are inherited from or shared with its ancestor. In certain embodiments, two mList objects are used during the search. These mList objects include an update move list object (mUpdate) and a search move list object (mSearch). The update mList inode is used during an object search to duplicate the moves done for the object. The update move list object is initialized with the starting root of the xTree of the object. The search mList inode is used during a dependent object search only. It is used to find shared blocks moved in the ancestor object. The search move list object contains the xTree of the ancestor object after all moves are complete.

When performing a depth-first search operation, the shared block movement module 420 performs a plurality of operations. More specifically, the shared block movement module 420 starts the depth-first search operation by descending to a leftmost leaf block. The shared block movement module 420 then determines if the block meets the criteria to be moved. If so the shared block movement module 420 proceeds with moving the blocks. The shared block movement module 420 then continues to the next leaf block moving the block if necessary. After visiting all leaf blocks for one indirect block page ascend, the shared block movement module 420 determines if the indirect page just visited meets the criteria to be moved. If so the shared block movement module 420 proceeds with moving the blocks. The shared block movement module 420 then descends the next indirect block to the leaf block and repeats. This process is repeated until all blocks have been visited.

When performing a depth-limited search operation, the shared block movement module 420 does not descend any further when it encounters a block which is inherited from its ancestor. This is possible because all blocks requiring movement in the ancestor have already been moved. Therefore any block lower than the inherited block has already been moved if necessary. An inherited block moved in the ancestor is also moved in the child object. The depth-limited search should recognize blocks inherited which have already been moved in the ancestor. The equivalent logical blocks from the mSearch inode and the object are compared. A mSearch block address (blockaddr) represents a moved block only if the blockaddr's generation match (indicating both objects point to the same point-in-time (PIT) view of the logical block) and the blockaddr's block number (blkno) or tier identifier (tierId) don't match.

The shared block movement module 420 performs a plurality of operations when performing the depth-limited operation. More specifically, the shared block movement module 420 starts the depth-limited operation with the leftmost root block. The shared block movement module 420 then performs a lookup of the equivalent logical block in the mSearch inode's xTree. The shared block movement module 420 then compares the mSearch blockaddr to the object's blockaddr. When performing the compare the shared block movement module 420 determines if the mSearch inode's blockaddr exactly matches the object's blockaddr. If the blockaddr's exactly match, then the shared block movement module 420 does not change this blockaddr and does not descend further down this branch. When performing the compare the shared block movement module 420 also determines if the mSearch inode's blockaddr represents a moved block. If the mSearch inode's blockaddr is a moved block, the dependent object is updated to move to the location found in the mSearch inode. (See e.g., the discussion of inheriting moved blocks) and the shared block movement module 420 does not descend further down this branch. The shared block movement module 420 then determines if the block meets the criteria to be moved. If so the shared block movement module 420 proceeds with moving the blocks and then descends the tree. Otherwise, the shared block movement module 420 does not change this block and then descends the tree. The shared block movement module 420 then ascends the tree and repeats. This process is repeated until all blocks have been visited.

When performing a moving blocks operation, once the shared block preservation system 150 determines a block needs to be moved, a plurality of steps are performed. More specifically, the shared block movement module 420 allocates a new block. This allocation is located either in the specified tier or above the fence. The shared block movement module 420 then copies the data from the original block to the new block. The shared block movement module 420 then adjusts a parent of the block to point to the new location. In certain embodiments, only the block location and tier location are updated. The rest of the fields are unchanged. This keeps the same semantics for snapshot preservation of the moved block as for the original block. The shared block movement module 420 then determines how to handle the original location. If the block is inherited then nothing is done with the original location. The parent snapshot either still points to the block or is handling the termination entries for the block. If the block is not referenced in any earlier snapshots or any child clones then the block is placed onto the commit termination list. If the block is referenced by a later snapshot, the original location is added to the termination list for the mUpdate object. The shared block movement module 420 then modifies the mUpdate object to reflect the new location of the block. If the object being traversed is a snapshot object, the only changes to the object are due to moved blocks. Therefore, updates to the mUpdate object could be skipped. Instead after the complete traversal of the snapshot object and commit of the moved blocks the root of the snapshot can be copied to the mUpdate object.

When performing an inheriting moved blocks operation, once the shared block preservation system 150 determines a block needs to be moved to match an ancestor a plurality of steps are performed. More specifically, the shared block movement module 420 adjusts parent of block to point to new location. The shared block movement module 420 then updates block location fields to match the mSearch block location fields. The rest of the fields of the block are unchanged. This keeps the same semantics for snapshot preservation of the moved block as for the original block.

With the shared block preservation system 150, a traversal order module 422 performs a plurality of operations. More specifically, when performing a traversal of objects requiring movement of shared blocks, the a traversal order module 422 moves shared blocks using at least one of two procedures, traversing blocks via Inode number order and traversing blocks via logical subtree order by visiting primary blocks first then any snapshots or clones dependent on the primary block.

Traversal based on the inode number order provides some security that all blocks moved are known and all objects are visited. Traversal based on logical subtree order also provides a plurality of advantages. For example, some operations requiring movement of shared blocks may be on individual files only. Traversal based upon logical subtree allows visiting of the logical subtree without visiting all of the other files within a file system. Additionally, the scalability of the data structures maintained improves by visiting a logical subtree independently. Traversal based upon logical subtree allows the original location of a moved block to be freed once the entire logical subtree has been traversed. If objects were visited in inode number order, the original location of moved blocks could not be freed until all objects in the file system had been traversed. Additionally, if file system traversal occurs using the inode number order it is possible a new snapshot or clone is created from an object not yet traversed. The new snapshot or clone could be created with an inode number which is smaller than the current traversal point causing the new object to be missed during the traversal.

The root of a traversal can be either a file system or a file. E.g. a shrink operation will traverse every object in the file system to find the blocks to be moved; a file migration will traverse only the file and its dependents.

With the shared block preservation system 150, the traversal order module 422 can perform a fileset traversal operation. If the root of a traversal is a file system, each fileset is traversed along with the other file system owned objects. The fileset traversal performs a plurality of steps for each allocated inode within the fileset. More specifically, if the allocated inode is a snapshot or a clone the fileset traversal skips the allocated inode. A snapshot or clone inode is processed as part of the logical subtree for the leading edge file. If the allocated inode is a regular file which is not either a clone or a snapshot then the fileset traversal operation traverses the primary file and its logical subtree. If the allocated inode is any other type of object, the fileset traversal operation traverses the object itself moving blocks as necessary.

With the shared block preservation system 150, the traversal order module 422 can perform a file traversal operation. With a file traversal operation, the traversal order module 422 performs a plurality of steps for a primary file. More specifically, if the object has snapshots, then the traversal order module 422 generates mList objects. The traversal order module 422 then traverses all of the blocks of the regular file moving blocks as necessary and updates the mList objects. If the file has snapshots then the traversal order module 422 traverses each snapshot starting with the most recent snapshot. The termination list for the snapshot is also traversed and updated.

If the snapshot has any clones then the traversal order module 422 traverses each clone. Each clone traversal proceeds as a primary traversal. This clone traversal includes creating its own unique mUpdate inode. The primary's mUpdate inode is used as the mSearch inode for the clone traversal. After traversal of all snapshots and clones based on the primary object the mList object cleanup occurs.

The traversal order module 422 specifically generates and organizes the move list. The mSearch created for a file maps the logical offsets of the file to the new location. It looks much like a snapshot of the file after the move is complete except it does not reflect any data modifications that might have occurred during the move operation.

More specifically, traversal of a primary file and its logical subtree often requires persistent information to provide a history of where all the blocks associated with the logical subtree have moved. This information also provides a mechanism for restarting an in-progress traversal. Before the traversal begins a plurality of objects are generated. More specifically, a move list inode (mUpdate) is generated. The primary object's inode points to this inode. Additionally, a header page is allocated for the mUpdate inode. The header page contains the information defining the type of blocks to be moved and the current progress of the move traversal. The mUpdate's inode points to this page.

A move list inode preserves the moved block locations based on the logical offset of the file. This includes indirect blocks and data blocks. A mUpdate and a mSearch inode are both examples of a move list inode. During the traversal of an object the type of object and type of traversal determines which of the mSearch and mUpdate objects are needed.

The traversal of a primary file does not use a mSearch inode. This traversal generates a new mUpdate object at the beginning of the traversal. The traversal of a snapshot file as part of the logical subtree of a primary file uses the mUpdate inode from the primary as both its mSearch inode and its mUpdate inode.

When a clone is traversed, the inherited blocks may already have been moved during the traversal of an ancestor object. However the clone's owned blocks might need to be moved separately from the inherited view. The clone thus uses its own mUpdate inode to isolate the movement of both of these types of blocks for its logical subtree. If the clone has no snapshots then the mUpdate inode is not needed. The clone's mUpdate inode starts as a copy of the clone itself. Like a snapshot, the traversal of a clone uses the primary's mUpdate inode as its mSearch inode. The clone's mUpdate inode is then used as the mSearch inode for subsequent traversal of its logical subtree. Additionally traversal of a clone file's logical subtree often requires separate data recovery information to have a history of where to start an interrupted move operation. The clone's mUpdate object points to this information like a primary file. If the clone traversal is the target object of an isolate traversal this clone traversal does not have a mSearch inode since no ancestors are being traversed.

After completion of traversal of a logical subtree the mUpdate should be cleaned up. The cleanup for a clone's mUpdate object is performed when its branch of the logical subtree has been completed. Cleanup involves a plurality of steps. More specifically, when performing a cleanup operation, the traversal order module 422 frees the original location for each entry in the termination list of the mUpdate. Additionally, the traversal order module 422 releases the header page for the mUpdate inode. Additionally, the traversal order module 422 clears mUpdate inode information from a primary's inode. Additionally, the traversal order module 422 can now remove the mUpdate inode. Its xTree is not processed on removal. (Removal looks much like removal of a snapshot.)

Although the present invention has been described in detail, it should be understood that various changes, substitutions and alterations can be made hereto without departing from the spirit and scope of the invention as defined by the appended claims.

What is claimed is:

1. A computer-implemented method for tracking blocks moved within a file system, comprising:
associating tracking information with a base object within the file system;
tracking movement of the base object via the tracking information; and,
adjusting information relating to an associated object of the base object derived from the base object.

2. The method of claim 1, wherein:
the associated object comprises at least one of a snapshot object and a clone object.

3. The method of claim 2, further comprising:
expanding the tracking information to identify objects associated with the associated object but not the base object.

4. The method of claim 1, wherein:
a plurality of base objects are moved while maintaining unchanged any shared state objects.

5. The method of claim 1, wherein.
the movement of the blocks within the file system comprise at least one of reducing the size of a file system, moving data across storage tiers, a defragmentation operation, a file system repair utility operation, and a clone file snapshot operation, the clone file snapshot operation splitting a clone file from a base file when the clone file includes snapshots.

6. The method of claim 1, wherein:
the tracking information is stored within a move list, the move list comprising information for each block, the information for each block identifying where the block was originally located and to where the block was moved.

7. A system comprising:
a processor;
a data bus coupled to the processor; and
a computer-usable medium embodying computer program code, the computer-usable medium being coupled to the data bus, the computer program code used for tracking blocks moved within a file system and comprising instructions executable by the processor and configured for:
associating tracking information with a base object within the file system;
tracking movement of the base object via the tracking information; and,
adjusting information relating to an associated object of the base object derived from the base object.

8. The system of claim 7, wherein:
the associated object comprises at least one of a snapshot object and a clone object.

9. The system of claim 8, further comprising:
expanding the tracking information to identify objects associated with the associated object but not the base object.

10. The system of claim 7, wherein:
a plurality of base objects are moved while maintaining unchanged any shared state objects.

11. The system of claim 7, wherein.
the movement of the blocks within the file system comprise at least one of reducing the size of a file system, moving data across storage tiers, a defragmentation operation, a file system repair utility operation, and a clone file snapshot operation, the clone file snapshot operation splitting a clone file from a base file when the clone file includes snapshots.

12. The system of claim 7, wherein:
the tracking information is stored within a move list, the move list comprising information for each block, the information for each block identifying where the block was originally located and to where the block was moved.

13. A non-transitory, computer-readable storage medium embodying computer program code, the computer program code comprising computer executable instructions configured for:
associating tracking information with a base object within the file system;
tracking movement of the base object via the tracking information; and,
adjusting information relating to an associated object of the base object derived from the base object.

14. The non-transitory, computer-readable storage medium of claim 13, wherein the associated object comprises at least one of a snapshot object and a clone object.

15. The non-transitory, computer-readable storage medium of claim 14, wherein expanding the tracking information to identify objects associated with the associated object but not the base object.

16. The non-transitory, computer-readable storage medium of claim 13, wherein:
a plurality of base objects are moved while maintaining unchanged any shared state objects.

17. The non-transitory, computer-readable storage medium of claim 13, wherein the movement of the blocks within the file system comprise at least one of reducing the size of the file system, moving data across storage tiers, a defragmentation operation, a file system repair utility operation, and a clone file snapshot operation, the clone file snapshot operation splitting a clone file from a base file when the clone file includes snapshots.

18. The non-transitory, computer-readable storage medium of claim 13, wherein:
the tracking information is stored within a move list, the move list comprising information for each block, the information for each block identifying where the block was originally located and to where the block was moved.

19. The non-transitory, computer-readable storage medium of claim 13, wherein the computer executable instructions are deployable to a client system from a server system at a remote location.

20. The non-transitory, computer-readable storage medium of claim 13, wherein the computer executable instructions are provided by a service provider to a user on an on-demand basis.
